(19) United States
(12) Patent Application Publication
(10) Pub. No.: US 2026/0260429 A1
(43) Pub. Date: Sep. 3, 2026

(54) METHODS, APPARATUS AND SYSTEMS FOR TEXT-GUIDED VIRTUAL TRY ON AND FOR TRAINING AN AI MODEL FOR TEXT-GUIDED VIRTUAL TRY ON

(71) Applicant: L'Oreal, Paris (FR)

(72) Inventors: Ruowei JIANG, Mississauga (CA); Sidharth SINGLA, Etobicoke (CA)

(73) Assignee: L'Oreal, Paris (FR)

(21) Appl. No.: 19/067,395

(22) Filed: Feb. 28, 2025

(51) Int. Cl. G06T 19/00; G06F 40/40

(52) U.S. Cl. CPC G06T 19/00; G06F 40/40

(57) ABSTRACT

There is provided methods, apparatus, and systems for text-guided makeup try-on. The method comprises extracting text embeddings from text input comprising makeup features. The method comprises mapping the text embeddings to the makeup features. The method comprises providing the makeup features to a virtual try on (VTO) system, the VTO system capable of rendering an output image, using a rendering engine of the VTO system, by applying a makeup product to an input image, the makeup product determined based on the makeup features. There is further provided methods, apparatus, and systems for training an AI model for text-guided makeup try-on. The method comprises generating training texts comprising training makeup features using a large language model (LLM). The method comprises extracting training text embeddings from the training texts. The method comprises training the AI model to predict the training makeup features based on the training text embeddings.

### FIELD OF INVENTION

The present disclosure relates to image processing and augmented reality and more particularly to methods, apparatus and systems for text-guided virtual try on of makeup and for training an artificial intelligence (AI) model for text-guided virtual try on of makeup.

### BACKGROUND

Virtual Try On (VTO) systems enable users to try on products (for example, makeup products, hair products, and nail products) virtually on a computing device before purchasing the products. The VTO system may provide a user of the VTO system with a “tap and try” feature, where a limited number of makeup products from a catalogue are presented to the user for virtual try on. This approach limits the options and flexibility, since not all the makeup products from the catalogue may be presented to the user. Alternatively, the VTO system may enable the user to enter numerical values for makeup features associated with a makeup product. In this case, the VTO system will need to perform complex calibrations to match all products with specific product characteristics. Moreover, the selection of makeup products may be complicated for the user.

Improved techniques are desired for selecting makeup products in a VTO system that are both flexible and user friendly.

### SUMMARY

There is provided a computer-implemented method for text-guided makeup try-on comprising executing on a processor one or more steps. The method comprises extracting, using a pre-trained text encoder, text embeddings from text input comprising makeup features. The method comprises mapping, using a mapping AI model, the text embeddings to the makeup features. The method comprises providing the makeup features to a virtual try on (VTO) system, the VTO system capable of rendering an output image, using a rendering engine of the VTO system, by applying a makeup product to an input image, the makeup product determined based on the makeup features.

The method may further comprise providing the output image for display on the VTO system.

The method may further comprise training the AI model. Training the AI model may comprise generating, using a large language model (LLM), training makeup features. Training the AI model may comprise generating, using the LLM, training texts comprising the training makeup features. Training the AI model may comprise extracting, using the pre-trained text encoder, training text embeddings from the training texts. Training the AI model may comprise training the AI model to predict the training makeup features based on the training text embeddings by minimizing a loss function. Generating the training texts may comprise generating template training texts using the LLM, and generating the training texts by combining the template training texts and the training makeup features. The loss function may comprise a combination of L1 Loss and Cross-Entropy Loss. The L1 Loss may be used for color and the Cross-Entropy Loss may be used for gloss and wetness.

The method may further comprise rendering the output image using the rendering engine of the VTO system.

The makeup features may be RGB color, gloss, and wetness. The makeup features may be numerical values representing RGB color, gloss, and wetness.

The pre-trained text encoder may be a multi-model model. The pre-trained text encoder may be a Contrastive Language-Image Pre-Training (CLIP) text encoder.

The makeup product may be lipstick, eyeshadow, nail paint, hair color, or foundation.

The AI model may be a neural network. The neural network may comprise fully connected (FC) and rectified linear unit (RELU) layers.

According to a further aspect of the disclosure, there is provided a computer-implemented method for training an AI model for text-guided makeup try-on comprising executing on a processor one or more steps. The method comprises generating, using a large language model (LLM), training makeup features. The method comprises generating, using the LLM, training texts comprising the training makeup features. The method comprises extracting, using a pre-trained text encoder, training text embeddings from the training texts. The method comprises training the AI model to predict the training makeup features based on the training text embeddings by minimizing a loss function.

Generating the training texts may comprise generating template training texts using the LLM, and generating the training texts by combining the template training texts and the training makeup features.

The loss function may comprise a combination of L1 Loss and Cross-Entropy Loss. The L1 Loss may be used for color and the Cross-Entropy Loss may be used for gloss and wetness.

The method may further comprise performing any of the operations described above in connection with the first aspect of the disclosure.

According to a further aspect of the disclosure, there is provided a system comprising at least one computing device. The system comprises a pre-trained text encoder to extract text embeddings from text input comprising makeup features. The system comprises a mapping AI model to map the text embeddings to the makeup features, the makeup features capable of configuring a rendering engine of a virtual try on (VTO) system to render an output image by applying a makeup product to an input image, the makeup product determined based on the makeup features.

The system may further comprise the VTO system.

The system may further comprise performing any of the operations described above in connection with the first aspect of the disclosure.

### BRIEF DESCRIPTION OF DRAWINGS

FIG. 1 is an illustration of a computing environment, in accordance with an embodiment, such as for performing a virtual try on.

FIG. 2 is a flowchart of operations such as for a computer implemented method in accordance with an embodiment.

FIG. 3 is a flowchart of operations such as for a computer implemented method in accordance with an embodiment.

FIG. 4 is a flowchart such as for a computer implemented method in accordance with an embodiment.

FIG. 5 is a flowchart such as for a computer implemented method in accordance with an embodiment.

FIG. 6 is a mapping network in accordance with an embodiment.

FIG. 7 is an illustration of a user interface interaction in which a plurality of text based queries are received and virtual try on effects are applied to a user image.

### DETAILED DESCRIPTION

In accordance with embodiments herein, there is described one or more methods, systems, apparatus and techniques for text-guided virtual try on.

VTO may provide users with the ability to try on various products (for example, makeup, hair, and nail products) virtually on a device using either the camera (live video mode) or a picture (photo mode). The user may choose the product they want to apply or enter text describing the product, and the VTO processes the input (video stream or image) to apply a recolouring method and output the processed image that is shown to the user. In live mode this may happen several times per second with a target of 30 frames per second (FPS) on a mobile device.

At a high level, VTO may comprise the following steps: input, detect user feature, recolor user feature. At the input step the image may be provided to be recolored. In case of a live mode this image may be extracted from the video stream of the camera. Detect the user feature may represent the method used to segment the user feature (e.g., hair, lips, eyes, etc.) in the image from the rest (face, background, etc.) and export a mask which will be used to apply the recoloring. Recolor the user feature may be the process of replacing each original pixel of the user feature in the image with a new value from a target color.

The VTO system may provide a user of the VTO system with a “tap and try” feature, where a limited number of makeup products from a catalogue are presented to the user for virtual try on. This approach limits the options and flexibility, since not all the makeup products from the catalogue may be presented to the user. Alternatively, the VTO system may enable the user to enter numerical values for makeup features associated with a makeup product. In this case, the VTO system will need to perform complex calibrations to match all products with specific product characteristics. Moreover, the selection of makeup products may be complicated for the user. As an alternative solution, text-to-image generative AI models, such as Stable Diffusion, DALL-E, and GLIDE, may be used. However, the results using these types of AI models often show artifacts and lack precision in generating the desired makeup product. Moreover, these types of AI models may lack desired performance levels.

The user task of selecting a makeup product for virtual try on may be made more efficient, flexible, and user-friendly using text-guided virtual try on. The user may select a makeup product for virtual try on by providing the VTO system with a text input comprising makeup features associated with a makeup product. Text embeddings may be extracted from the text input using a pre-trained text encoder, such as Contrastive Language-Image Pre-Training (CLIP). An AI model may be used to map the text embeddings to the makeup features. The AI model may for example output a vector of numerical values for the makeup features. The makeup features may be provided as input to the VTO system for rendering an output image by applying the makeup product associated with the makeup features to an input image of the user. The user is thus provided with a user-friendly way to select a makeup product for virtual try on that is flexible and not limited to a small subset of the available makeup products and without having to enter complicated numerical parameters for the makeup product.

Training the AI model for mapping the text embeddings to the makeup features may comprise generating a training dataset using a large language model (LLM). LLMs have become increasingly popular and have found good use in tasks like natural language understanding, natural language generation, and reasoning. The generative pre-trained transformer (GPT) family is a popular example of LLMs. They can mimic human intelligence and are trained on huge amounts of text data for learning. They can be used to derive and accumulate relevant information related to a product or a field and thus aid in training new AI models. The LLM may generate makeup features, such as lipstick product features, such as color shades, gloss presets, and wetness. The LLM may also generate training texts comprising these makeup features. These LLM-generated training texts may be used as a dataset for training the AI model.

### VTO Application

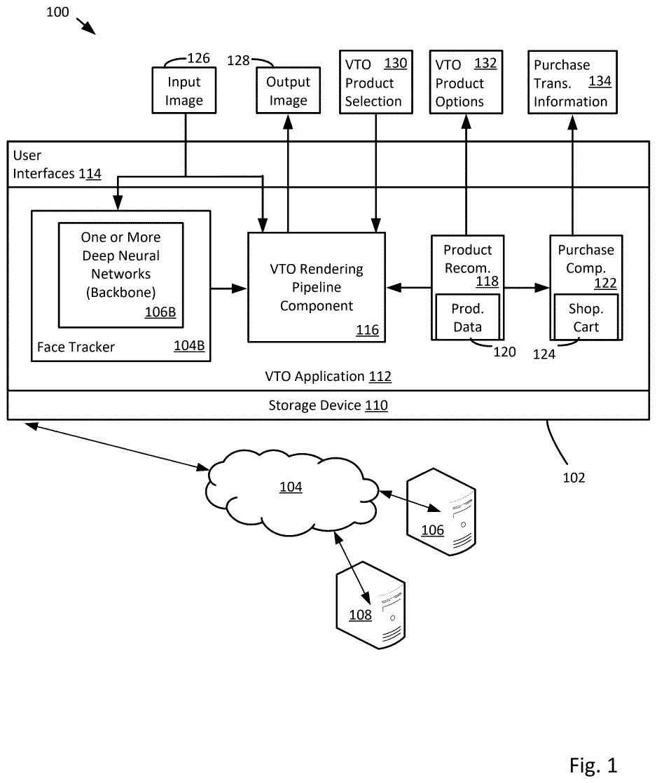

FIG. 1 is an illustration of a computing environment 100, in accordance with an embodiment, such as for practicing one or more method aspects. Computing environment 100 shows a user computing device 102, such as a smartphone, a communications network 104, a server 106 and a server 108. Communications network 104 comprises wired and/or wireless networks, which may be public or private and may include, for example the internet. Server 106 comprises a server computing device such as for providing a website. Server 108 comprises a server computing device such as for providing e-commerce transaction services. Though shown separately, the servers 106 and 108 can comprise one server device. Computing environment 100 is simplified. For example, not shown are payment transaction gateways and other components such as for completing an e-commerce transaction.

Computing device 102 comprises a storage device 110 (e.g., a non-transient device such as a memory and/or solid state drive, etc.) for storing instructions that, when executed by a processor (not shown), cause the computing device 102 to perform operations such as a computer implemented method. Storage device 110 stores a virtual try on application 112 comprising components such as software modules providing, a user interface 114, face tracker 104B with one or more deep neural networks 106B, a VTO rendering pipeline component 116, a product recommendation component 118 with product data 120, and a purchasing component 122 with shopping cart 124 (e.g. purchase data).

In an embodiment, VTO application is a web-based application such as is obtained from server 106. Though not shown, user device 102 may store a web-browser for execution of web-based VTO application 112. In an embodiment, VTO application is a native application in accordance with an operating system (also not shown) and software development requirements that may be imposed by a hardware manufacturer, for example, of the user device 102. The native application can be configured for web-based communication or similar communications to servers 106 and 108, as is known.

FIG. 1 shows various input and output data or information associated with a use of VTO application 112, for example. Such includes an input image 126 of the user to be processed for a VTO experience, an output image 128 to which product effects are simulated providing a VTO experience, a VTO product selection 130 comprising user input selecting one or more product effects to be simulated, VTO products options 132 comprising options for products to be virtually tried on, for example for selection by a user of device 102, and purchase transaction information 134 comprising purchase information provided to and/or received from a user to purchase a product. The VTO Product Selection 130 and the VTO Product Options 132 may be accomplished using the text-guided virtual try on, which may be stored on the storage device 110 as a component of the VTO Application 112 or on server 106 or server 108.

In an embodiment, via one or more of user interfaces 114, VTO product options 132 are presented for selection to virtually try on by simulating effects on an input image 126. In an embodiment the VTO product options 132 are derived from or associated to product data 120. In an embodiment, the product data can be obtained from server 106 and provided by the product recommendation component 118. Though not shown, user or other input may be received for use to determine product recommendations. The user may be prompted, such as via one of interfaces 114 to provide input for determining product recommendations. In an embodiment, the product recommendation component 118 communicates with server 106. Server 106, in an embodiment, determines the recommendation based on input received via component 118 and provides product data accordingly. User interface 114 can present the VTO product choices, for example, updating the display of same responsive to the data received as the user browses or otherwise interacts with the user interface. In one embodiment, the user input for selecting a product and related options may be user text input.

In an embodiment, the one or more user interfaces provide instructions and controls to obtain the input image 126, and VTO product selection input 130 such as an identification of one or more VTO products to try on. In an embodiment, the products may be recommended to a user. In an embodiment, the products may be selected by a user without having been recommended per se. That is, instances of the products may be presented such as from a data store of products and the user selects an instance to virtually try on. In an embodiment, the products may be selected by a user through text input. In an embodiment, the input image 126 is a user's face image, for example, which can be a still image or a frame from a video. In an embodiment, the input image 126 can be received from a camera (not shown) of device 102 or from a stored image (not shown). The input image 126 is provided to face tracker 104B such as for processing to detect objects in the input image 126 using one or more deep neural networks 106B. In an example, the network classifies, localizes or segments for a specific object in the image.

In an embodiment, output (not shown) from the face tracker 104B, such as classification results, localization results or segmentation results for one or more detected objects, is provided to VTO rendering pipeline component 116. The input image 126 is also provided (e.g. made available) to component 116. The VTO product selection 130 is also provided to component 116 for determining which effects are to be rendered. In an embodiment related to makeup simulation, one or more effects can be indicated such as for any one or more of the product categories comprising: lip, eye shadow, eyeliner, blush, etc.

VTO rendering pipeline component 116, in an embodiment, determines whether to render one or more product effects to the input image 126 to simulate a try on. In an embodiment such as one that is related to makeup, for example, responsive to facemask classification output, VTO rendering pipeline component 116 can determine not to render a product effect to all or a portion of a face, for example, because a mask is detected. When a facemask is detected, for example, VTO rendering pipeline component 116 can trigger the user interface 414 to ask the user to remove the facemask. A new image can be received and processed by face tracker 104B. In an embodiment, images are continuously received as a component of a live stream (e.g. a selfie video).

For example, in an embodiment where more than one product effect is to be applied to the input image, the VTO rendering pipeline component 116 may render effects (e.g. on or to) for the input image 126 such as by drawing (rendering) effects in layers, one layer for each product effect, to produce output image 128. Layering may be assisted by use of overlays in some examples. Some examples may change pixel values of the input image itself without overlaying, per se.

Portions of the operations of VTO rendering pipeline component 116 (e.g. such as for drawing the layers) can be performed by a graphics processing unit, in an embodiment. The rendering is in accordance with product data 120 as selected by VTO product selection 130 and is responsive to the location of detected objects. For example, a VTO product selection of a lipstick, lip gloss or other lip related product invokes the application of an effect to one or more detected mouth or lip-related objects at respective locations. Similarly a brow related product selection invokes the application of a selected product effect to the detected eyebrow objects. Typically, for symmetrical looks, the same brow effects are applied to each brow, the same lip effect to each lip or the same eye effect to each eye region, but this need not be the case. In an example, the rendering is applied to a region that is relative to the detected objects, such as adjacent one or more such detected objects. Some VTO product selections comprise a selection of more than one product such as coordinated products for brows and eyes or other combinations of detected objects. VTO rendering pipeline component 116 can render each effect, for example, one at a time until all effects are applied. The order of application can be defined by rules or in the selection of products e.g. lipstick before a top gloss.

In an embodiment where an occluding object is detected and the location is determined, for example, as represented in a segmentation mask, the rendering can be responsive to such a segmentation mask. Rendering of an effect can be applied to portions of the face that are not occluded. A segmentation mask can indicate the pixels of the face that are available to (e.g. may) receive an effect such as a makeup effect and those pixels that are not available to receive an effect.

User interfaces 114 provide the output image 128. Output image 128, in an embodiment, is presented as a portion of a live stream of successive output images (each an example 128) such as where a selfie video is augmented to present an augmented reality experience. In an embodiment, output image 128 is presented along with the input image 126, such as in a side-by-side display for comparison. In an embodiment, output image 128 can be saved (not shown) such as to storage device 110 and/or shared (not shown) with another computing device.

In an embodiment, (not shown) the input images comprise input images of a video conferencing session and the output images comprise a video that is shared with another participant (or more than one) of a video conferencing session. In an embodiment the VTO application is a component or plug in of a video conferencing application (not shown) permitting the user of device 102 to wear makeup during a video conference with one or more other conference participants.

### Text-Guided Virtual Try On

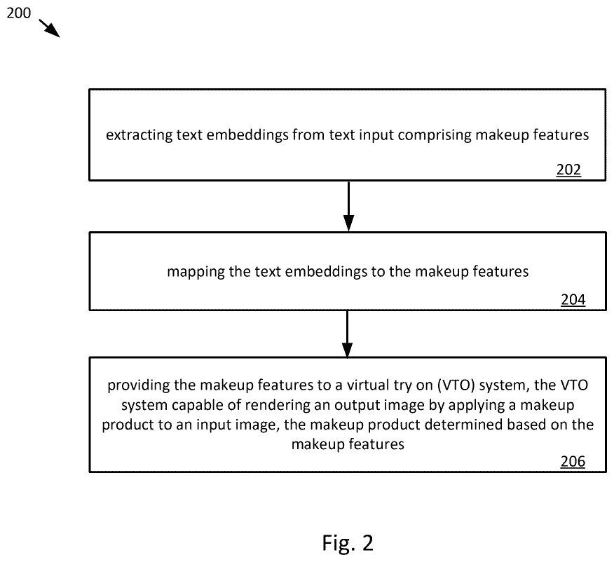

Reference is now made to FIG. 2, which shows a computer-implemented method 200 for text-guided virtual try on of a makeup product. The method 200 comprises extracting 202, using a pre-trained text encoder, text embeddings from text input comprising makeup features. The pre-trained text encoder takes natural language text as input and outputs a text embedding. A text embedding is a numerical representation of the text. For example, a text embedding may comprise a high dimensional vector. The text embedding projects the text into a high dimensional space. Semantically similar text may be located close to one another in the high dimensional space. Different pre-trained text encoders may be used. The pre-trained text encoder may be a multi-model model. The Contrastive Language-Image Pre-Training (CLIP) model, for example, may be used as the pre-trained text encoder. CLIP is trained on image and text pairs and provides zero-shot capabilities. It uses a contrastive loss to match pairs of images and texts. CLIP may be well-suited to the present application because it is trained on text and image pairs and the present application relates to image manipulation by text input. However, other text encoders may be used, such as GPT and BERT.

The method 200 further comprises mapping 204, using a mapping AI model, the text embeddings to the makeup features. The mapping AI model may be a standard deep learning model that takes the text embeddings as input and is trained to extract makeup features from the text embeddings. The makeup features outputted by the AI model may be a vector of numerical values representing the makeup features for a makeup product that may be the parameters input to the renderer of the VTO system. The makeup features may comprise RGB color, gloss, and wetness. The makeup features may comprise numerical values representing RGB color, gloss, and wetness.

The method 200 further comprises providing 206 the makeup features to a virtual try on (VTO) system, the VTO system capable of rendering an output image 128, using a rendering engine of the VTO system, by applying a makeup product to an input image 126, the makeup product determined based on the makeup features. The appearance of the output image 128 is parameterized by a vector of graphics parameters. It is graphics-based and takes numerical input parameters such as color and texture parameters like wetness and gloss. The induction allows real-time rendering on portable devices with limited resources. The VTO system may render the output image 128, where the output image 128 is a simulation of a makeup product on the input image 126 based on the vector of numerical parameters representing makeup features provided to the VTO system. The VTO system may render or generate an output image 128 that is the input image 126 with the specified makeup product rendered thereon. The AI model is trained to generate numerical values representing makeup features that can serve as input to the VTO system.

The method 200 may further comprise providing the output image 128 for display on the VTO system. The output image 128 with the desired makeup product rendered thereon may be displayed on a display screen of the VTO system. The output image 128 may be a static image of the user. The output image 128 may also be a video stream of the user. For example, the output image 128 may be displayed on a display screen of a mobile device or on a computer screen of a computer. The makeup product may be lipstick, eyeshadow, nail paint, hair color, foundation, or any other makeup product.

The method 200 may further comprise training the AI model. Training the AI model may comprise generating, using a large language model (LLM), training makeup features. The LLM may be, for example, ChatGPT, and more specifically, ChatGPT 3.5. The LLM may generate makeup features, such as colors (that is, shades), gloss, and wetness. For example, the LLM may generate makeup features using the following prompt: “What are a few popular lipstick shades? What are popular gloss presets for a lipstick?” The LLM may also be used to map the natural language makeup features to numerical values. For example, the LLM may be used to map the color “Ruby Red” to the RGB values (220, 20, 60). In one embodiment, approximately 250 colors may be generated by the LLM. Glossiness comparisons may be generated for the presets obtained: Matte<Satin<Natural<Glossy<Smooth<Shiny.

Training the AI model may further comprise generating, using the LLM, training texts comprising the training makeup features. The LLM may be the same LLM used to generate the training makeup features or a different LLM. The training texts generated may describe a makeup product with certain makeup features. The training texts may resemble the type of natural language input texts that users may input into the VTO system. The following prompt may for example be used to generate the training texts: “Generate single line descriptions for lipstick and replace color with AAA”. The LLM may output a plurality of template training texts based on such a prompt, such as, for example, the following template training text: “I'm looking for AAA Lipstick, can you suggest where to find it?” The method may comprise generating the training texts by combining the template training texts and the training makeup features. For example, colors generated by the LLM may be selected to replace “AAA” in the template training text. In one embodiment, 200 colors may be selected. Gloss presets and wetness words may be selected and added to the training text. The following are example generated training texts: “I'm looking for Terracotta Glossy Lipstick, can you suggest where to find it?” and “The Wine hue of this Glossy Moisturizing Lipstick is rich and intense.” In one embodiment, approximately 5000 training texts may be generated as a training dataset. Some of the training texts may be set aside as validation texts. For example, of the 5000 generated training texts, 4500 may be used for training and 500 may be used for validating the AI model. The AI model may also be validated using unseen color shades. For example, 50 unseen color shades may be used to validate the AI model using the following text input: “put <color-name> color lipstick on lips”. The LLM may generate template training texts that are then combined with LLM-generated makeup features, as described above. The LLM may alternatively generate the training texts comprising the makeup features directly.

Training the AI model may further comprise extracting, using the pre-trained text encoder, training text embeddings from the training texts. During the training phase, the text embeddings may be extracted using the same pre-trained text encoder as during the inference phase, such as CLIP.

Training the AI model may further comprise training the AI model to predict the training makeup features based on the training text embeddings by minimizing a loss function. Training the AI model may comprise standard AI model training techniques, such as modifying the parameters of the AI model to minimize a loss function between the predicted output and the expected output. For example, if the training text comprises the color shade Ruby Red, it is known that the expected output should be the RGB values (220, 20, 60). The predicted RGB values may then be compared to the expected RGB values using a loss function. The parameters of the AI model may be modified until the loss function is less than a threshold. The loss function may comprise a combination of L1 Loss and Cross-Entropy Loss. The loss function for training the AI model may be Lₘₐₖₑᵤₚ=L_{color}+L_{wetness}+L_{gloss}. L_{color} may be L1 Loss for the RGB color. L_{wetness} and L_{gloss} may be Cross-Entropy Loss for wetness and gloss preset.

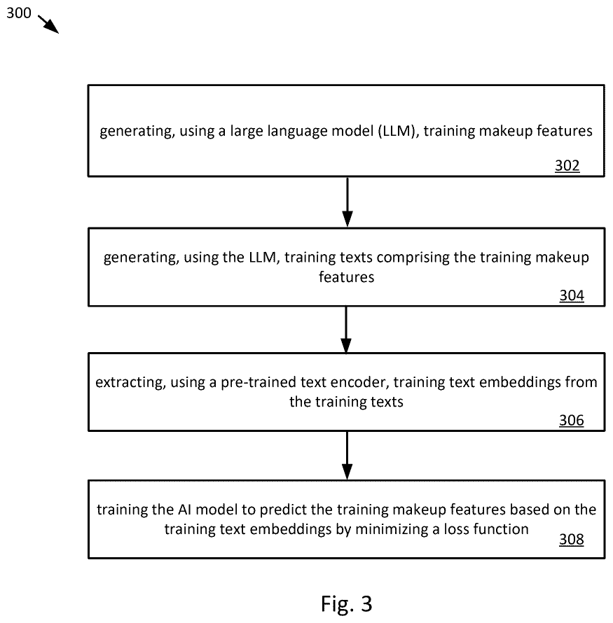

Reference is now made to FIG. 3, which shows a computer-implemented method 300 for training an AI model for text-guided makeup try-on. The method 300 comprises generating 302, using a large language model (LLM), training makeup features. The LLM may be, for example, ChatGPT, and more specifically, ChatGPT 3.5. The LLM may generate makeup features, such as colors (that is, shades), gloss, and wetness. For example, the LLM may generate makeup features using the following prompt: “What are a few popular lipstick shades? What are popular gloss presets for a lipstick?” The LLM may also be used to map the natural language makeup features to numerical values. For example, the LLM may be used to map the color “Ruby Red” to the RGB values (220, 20, 60). In one embodiment, approximately 250 colors may be generated by the LLM. Glossiness comparisons may be generated for the presets obtained: Matte<Satin<Natural<Glossy<Smooth<Shiny.

The method 300 further comprises generating 304, using the LLM, training texts comprising the training makeup features. The LLM may be the same LLM used to generate the training makeup features or a different LLM. The training texts generated may describe a makeup product with certain makeup features. The training texts may resemble the type of natural language input texts that users may input into the VTO system. The following prompt may for example be used to generate the training texts: “Generate single line descriptions for lipstick and replace color with AAA”. The LLM may output a plurality of template training texts based on such a prompt, such as, for example, the following template training text: “I'm looking for AAA Lipstick, can you suggest where to find it?” The method may comprise generating the training texts by combining the template training texts and the training makeup features. For example, colors generated by the LLM may be selected to replace “AAA” in the template training text. In one embodiment, 200 colors may be selected. Gloss presets and wetness words may be selected and added to the training text. The following are example generated training texts: “I'm looking for Terracotta Glossy Lipstick, can you suggest where to find it?” and “The Wine hue of this Glossy Moisturizing Lipstick is rich and intense.” In one embodiment, approximately 5000 training texts may be generated as a training dataset. Some of the training texts may be set aside as validation texts. For example, of the 5000 generated training texts, 4500 may be used for training and 500 may be used for validating the AI model. The AI model may also be validated using unseen color shades. For example, 50 unseen color shades may be used to validate the AI model using the following text input: “put <color-name> color lipstick on lips”. The LLM may generate template training texts that are then combined with LLM-generated makeup features, as described above. The LLM may alternatively generate the training texts comprising the makeup features directly.

The method 300 further comprises extracting 306, using the pre-trained text encoder, training text embeddings from the training texts. During the training phase, the text embeddings may be extracted using the same pre-trained text encoder as during the inference phase, such as CLIP.

The method 300 further comprises training 308 the AI model to predict the training makeup features based on the training text embeddings by minimizing a loss function. Training the AI model may comprise standard AI model training techniques, such as modifying the parameters of the AI model to minimize a loss function between the predicted output and the expected output. For example, if the training text comprises the color shade Ruby Red, it is known that the expected output should be the RGB values (220, 20, 60). The predicted RGB values may then be compared to the expected RGB values using a loss function. The parameters of the AI model may be modified until the loss function is less than a threshold. The loss function may comprise a combination of L1 Loss and Cross-Entropy Loss. The loss function for training the AI model may be Lₘₐₖₑᵤₚ=L_{color}+L_{wetness}+L_{gloss}. L_{color} may be L1 Loss for the RGB color. L_{wetness} and L_{gloss} may be Cross-Entropy Loss for wetness and gloss preset.

The text-guided virtual try on system may be a component of the VTO system 100 or the VTO Application 112. Alternatively, the text-guided virtual try on system may be a component of the server 106 or server 108. Alternatively, the text-guided virtual try on system may comprise the VTO system 100 or the VTO Application 112 as a component.

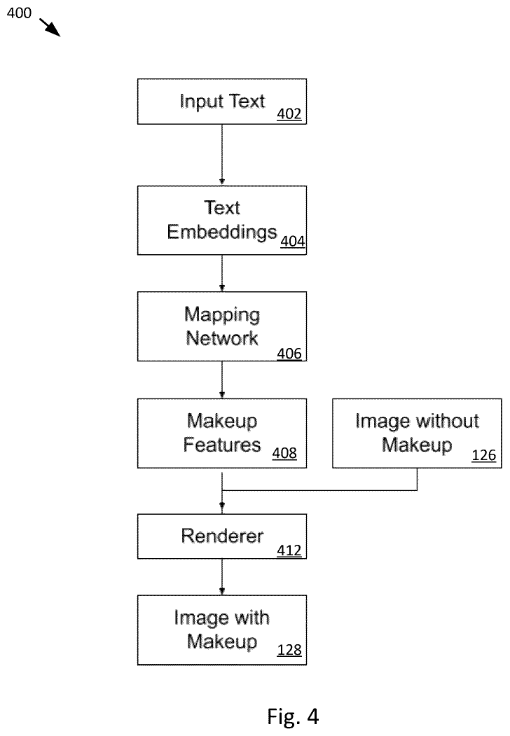

Reference is now made to FIG. 4, which shows a high-level schematic flowchart 400 of text-guided virtual try on. A user of the text-guided virtual try on system provides natural language input text 402 describing a makeup product that the user would like to try on virtually. A pre-trained text encoder, such as CLIP, extracts text embeddings 404 from the input text 402. The text embeddings 404 are provided to a mapping network 406 (that is, the mapping AI model). The mapping network 406 extracts makeup features 408 from the text embeddings 404. The makeup features 408 may be numerical values for the makeup features that may serve as parameters for the renderer 412. The makeup features 408 and the input image 126 (also referred to as the image without makeup) are provided as input to a renderer 412 of the VTO Application 112. The renderer 412 renders or generates an output image 128 (image with makeup). The output image 128 is the input image 126 of the user with the makeup described in natural language applied to the user.

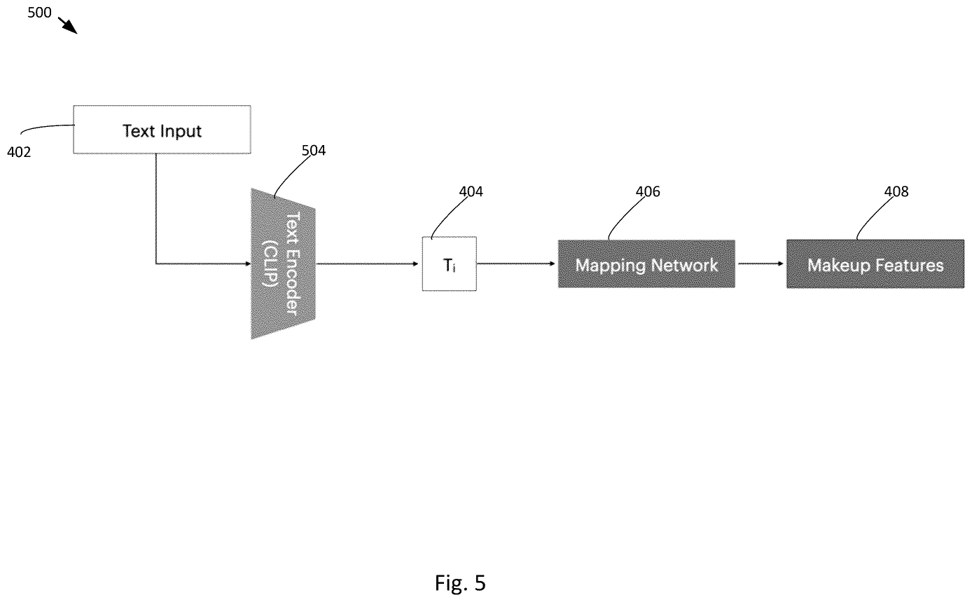

Reference is now made to FIG. 5, which shows a high-level schematic flowchart 500 of text-guided virtual try on. A user of the text-guided virtual try on system provides natural language text input 402 describing a makeup product that the user would like to try on virtually. A pre-trained text encoder 504, such as CLIP, extracts text embeddings, Tᵢ, 404 from the text input 402. The text embeddings 404 are provided to a mapping network 406 (that is, the mapping AI model). The mapping network 406 extracts makeup features 408 from the text embeddings 404. The makeup features 408 may be numerical values for the makeup features 408 that may serve as parameters for the renderer.

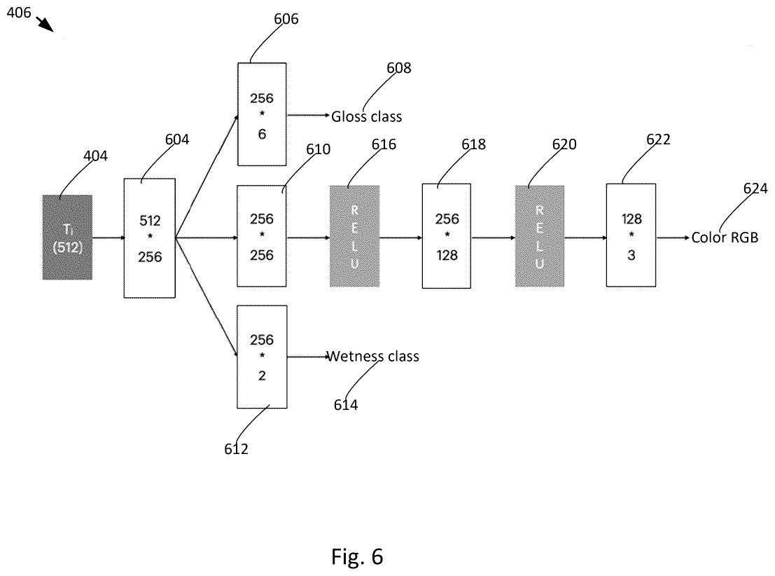

Reference is now made to FIG. 6, which shows the mapping AI model 406, also referred to as a mapping network. The mapping AI model 406 may be a neural network, as shown in FIG. 6. The mapping AI model 406 receives the text embeddings, Tᵢ, 404 as input. The text embeddings 404 may have 512 dimensions. The mapping AI model 406 may comprise fully connected (FC) layers 604, 606, 610, 612, 618, 622 and rectified linear unit (RELU) layers 616, 620. The mapping AI model 406 may output different makeup features, such as gloss 608, RGB color 624, and wetness 614. The outputted makeup features may be numerical values representing the makeup features that can serve as parameters or input for the renderer of the VTO system 100. The mapping AI model 406 may have some layers 604 used in common for all makeup features. The mapping AI model 406 may have some layers that are used exclusively for certain makeup features. For example, layer 606 may be used only for gloss 608, layer 612 may be used only for wetness 614, and layers 610, 616, 618, 620, and 622 may be used only for RGB color 624.

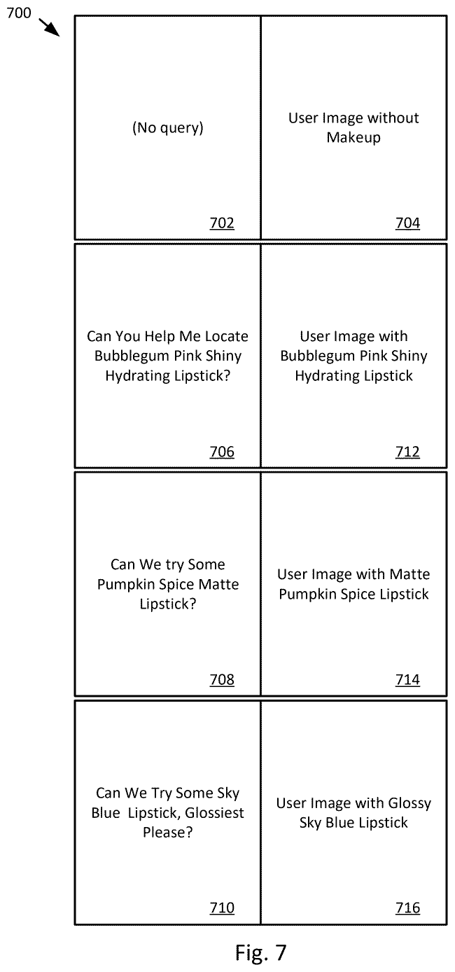

FIG. 7 is an illustration of a series 700 of user interface interactions in which an initial image without makeup 702 is received (e.g. without a query 704), followed by successive queries 706, 708 and 710 that illicit respective virtual try on responses 712, 714 and 716 presenting the initial user image with the applicable makeup applied thereto as determined from the respective query. FIG. 7 illustrates various forms of text-based query including information for the makeup type, the colour and a makeup feature/characteristic such as shine (gloss, matte, etc.).

The color outputs of the presently disclosed text-guided virtual try on model have been quantitatively evaluated in LAB space (L1 Loss) and wetness and gloss-preset outputs have been evaluated with Accuracy. Table 1 (below) exhibits results on 500 validation samples, presenting scores for the lipstick makeup features. For color loss in LAB space, a lower score is better. Results on the validation set corroborate learning of makeup features from text inputs using the present model.

TABLE 1
Results

| Metric | Score |
|---|---|
| Color L1 Loss (LAB space) | 6.5 |
| Gloss preset Accuracy | 100 |
| Wetness Accuracy | 100 |

The present model has also been compared against generative text-guided image editing models, such as StableDiffusion editing, InstructPix2Pix, and Null-text inversion with regards to color LAB L1 space, inference speed, and visually. To select the best-generated image from other models, different hyperparameter combinations are tuned. Selection is done by calculating the L1 LAB metric score (lipstick color) between each generated image and the ground truth image. Lipstick color for the models is predicted using the Deep Inverse Graphics Encoder. The prompt used for StableDiffusion editing and InstructPix2Pix is: “put <color-name> color lipstick on lips”. The prompt used for Null-text inversion is: “a lady with <color-name> lipstick on lips”. The prompt used for the present model is: “put <color-name> color lipstick on lips”. Comparisons on Color Loss and Inference Speed are presented in Table 2 (below). The present model scores the lowest for the L1 loss in the LAB space, substantiating it as the best approach for text guided makeup rendering. The inference speed benchmark is demonstrated using Intel® Xeon® CPU@2.20 GHz having 6 cores and 12 threads. The number of inference steps used for profiling generative models is 1. The increased number of inference steps leads the inference time to increase and thus the CPU may take a large amount of time to render results. For quantitative and visualization results, the default number of steps is used: 100 in InstructPix2Pix, 50 in Stable-Diffusion, and 10 in Null-text inversion. The present model's inference time includes the time to output the model's results and the renderer's results.

TABLE 2
Comparison of Results Against Other Models

| | Color | Inference |
|---|---|---|
| Model | Loss | Speed (s) |
| Stable-Diffusion | 72.48 | 43.8 |
| Null-text inversion | 57.75 | 42.130 |
| InstructPix2Pix | 51.7 | 138.76 |
| Our Model | 35.8 | 0.86 |

The present model does better than other models with regards to visual comparisons on some test color shades, particularly on unseen color shades. Across various types of color shades: reddish, pinkish, orangish, and bluish, the performance of the present model is notably superior compared to alternative approaches. Other methods struggle with orangish and bluish shades, often producing predominantly reddish or pinkish colors. The training set for the present model has some greyish shades that aided in learning grey color, such as ash grey. The training set does not have colors related to violet and watermelon, and still, the present model illustrates good color predictions for these color shades as well.

Other generative image editing models require hyper-parameter and prompt tuning, which may be challenging for a user. Without hyper-parameter and prompt tuning, the results of the other models are not optimal and the generated images are noisy and do not look natural. The present model does not require hyper-parameter or prompt tuning. The present model, unlike the other models, is capable of applying makeup to the right part of the image without altering other parts of the image (for example, the present model applies the lipstick perfectly to just the lips and not other parts of the image). The present model is capable of providing text-guided virtual try on on a mobile device.

It will be understood that corresponding system embodiments are disclosed for each of the method embodiments disclosed herein, for example where the system comprises respective components having computation circuitry configured to perform the operations of the computer implemented method embodiments.

In addition to computing device and method aspects, a person of ordinary skill will understand that computer program product aspects are disclosed, where instructions are stored in a non-transient storage device (e.g. a memory, CD-ROM, DVD-ROM, disc, etc.) and that, when executed, the instructions cause a computing device to perform any of the method aspects stored therein.

While the computing devices are described with reference to processors and instructions that, when executed, cause the computing devices to perform operations, it is understood that other types of circuitry than programmable processors can be configured. Hardware components comprising specifically designed circuits can be employed such as but not limited to an application specific integrated circuit (ASIC) or other hardware designed to perform specific functions, which may be more efficient in comparison to a general-purpose central processing unit (CPU) programmed using software. Thus, broadly herein an apparatus aspect relates to a system or device having circuitry (sometimes referenced as computational circuitry) that is configured to perform certain operations described herein, such as, but not limited, to those of a method aspect herein, whether the circuitry is configured via programming or via its hardware design.

Practical implementation may include any or all the features described herein. These and other aspects, features and various combinations may be expressed as methods, apparatus, systems, means for performing functions, program products, and in other ways, combining the features described herein. A number of embodiments have been described. Nevertheless, it will be understood that various modifications can be made without departing from the spirit and scope of the processes and techniques described herein. In addition, other steps can be provided, or steps can be eliminated, from the described process, and other components can be added to, or removed from, the described systems. Accordingly, other embodiments are within the scope of the following claims.

Throughout the description and claims of this specification, the word “comprise” and “contain” and variations of them mean “including but not limited to” and they are not intended to (and do not) exclude other components, integers or steps. Throughout this specification, the singular encompasses the plural unless the context requires otherwise. In particular, where the indefinite article is used, the specification is to be understood as contemplating plurality as well as singularity, unless the context requires otherwise.

Features, integers characteristics, compounds, chemical moieties or groups described in conjunction with a particular aspect, embodiment or example of the invention are to be understood to be applicable to any other aspect, embodiment or example unless incompatible therewith. All the features disclosed herein (including any accompanying claims, abstract and drawings), and/or all the steps of any method or process so disclosed, may be combined in any combination, except combinations where at least some of such features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

What is claimed is:

1. A computer-implemented method for text-guided makeup try-on comprising executing on a processor one or more steps comprising:
extracting, using a pre-trained text encoder, text embeddings from text input comprising makeup features;
mapping, using a mapping AI model, the text embeddings to the makeup features; and
providing the makeup features to a virtual try on (VTO) system, the VTO system capable of rendering an output image, using a rendering engine of the VTO system, by applying a makeup product to an input image, the makeup product determined based on the makeup features.

2. The computer-implemented method of claim 1, further comprising providing the output image for display on the VTO system.

3. The computer-implemented method of claim 1, further comprising training the AI model, wherein training the AI model comprises:
generating, using a large language model (LLM), training makeup features;
generating, using the LLM, training texts comprising the training makeup features;
extracting, using the pre-trained text encoder, training text embeddings from the training texts; and
training the AI model to predict the training makeup features based on the training text embeddings by minimizing a loss function.

4. The computer-implemented method of claim 3, wherein generating the training texts comprises:
generating template training texts using the LLM; and
generating the training texts by combining the template training texts and the training makeup features.

5. The computer-implemented method of claim 3, wherein the loss function comprises a combination of L1 Loss and Cross-Entropy Loss.

6. The computer-implemented method of claim 5, wherein the L1 Loss is used for color and the Cross-Entropy Loss is used for gloss and wetness.

7. The computer-implemented method of claim 1, further comprising rendering the output image using the rendering engine of the VTO system.

8. The computer-implemented method of claim 1, wherein the makeup features are RGB color, gloss, and wetness.

9. The computer-implemented method of claim 1, wherein the makeup features are numerical values representing RGB color, gloss, and wetness.

10. The computer-implemented method of claim 1, wherein the pre-trained text encoder is a multi-model model.

11. The computer-implemented method of claim 1, wherein the pre-trained text encoder is a Contrastive Language-Image Pre-Training (CLIP) text encoder.

12. The computer-implemented method of claim 1, wherein the makeup product is lipstick, eyeshadow, nail paint, hair color, or foundation.

13. The computer-implemented method of claim 1, wherein the AI model is a neural network.

14. The computer-implemented method of claim 13, wherein the neural network comprises fully connected (FC) and rectified linear unit (RELU) layers.

15. A computer-implemented method for training an AI model for text-guided makeup try-on comprising executing on a processor one or more steps comprising:
generating, using a large language model (LLM), training makeup features;
generating, using the LLM, training texts comprising the training makeup features;
extracting, using a pre-trained text encoder, training text embeddings from the training texts; and
training the AI model to predict the training makeup features based on the training text embeddings by minimizing a loss function.

16. The computer-implemented method of claim 15, wherein generating the training texts comprises:
generating template training texts using the LLM; and
generating the training texts by combining the template training texts and the training makeup features.

17. The computer-implemented method of claim 15, wherein the loss function comprises a combination of L1 Loss and Cross-Entropy Loss.

18. The computer-implemented method of claim 17, wherein the L1 Loss is used for color and the Cross-Entropy Loss is used for gloss and wetness.

19. A system comprising at least one computing device, the system comprising:
a pre-trained text encoder to extract text embeddings from text input comprising makeup features; and
a mapping AI model to map the text embeddings to the makeup features, the makeup features capable of configuring a rendering engine of a virtual try on (VTO) system to render an output image by applying a makeup product to an input image, the makeup product determined based on the makeup features.

20. The system of claim 19, further comprising the VTO system.
